(19) United States
(12) Patent Application Publication
(10) Pub. No.: US 2024/0144334 A1
(43) Pub. Date: May 2, 2024

(54) EXCEPTIONS REMEDIATION SYSTEM AND METHOD FOR ASSET TRANSFER

(71) Applicant: BLUE WATER FINANCIAL TECHNOLOGIES, LLC, St. Louis Park, MN (US)

(72) Inventors: Alan Pervez Qureshi, Excelsior, MN (US); Ellen Qureshi, St. Louis Park, MN (US); Joe Strandmo, St. Louis Park, MN (US); Kevin Suolongfu, St. Louis Park, MN (US); Brian Agre, St. Louis Park, MN (US); Peter Kupchick, St. Louis Park, MN (US); Josh Freivogel, San Francisco, CA (US); Connor McCollum, St. Louis Park, MN (US); Jay Patel, St. Louis Park, MN (US)

(21) Appl. No.: 18/049,801

(22) Filed: Oct. 26, 2022

(51) Int. Cl. G06Q 30/06

(52) U.S. Cl. CPC G06Q 30/0609

(57) ABSTRACT

A system is disclosed. The system has a remediation module, comprising computer-executable code stored in non-volatile memory, a processor, a buyer device of a buyer, and a seller device of a seller. The remediation module, the processor, the buyer device, and the seller device are configured to receive asset data of the seller, receive exception rules of the buyer, determine exceptions of the asset data based on the exception rules, display the exceptions via at least one of the buyer device or the seller device, and update the asset data based on the displayed exceptions.

### FIELD OF THE INVENTION

The present disclosure generally relates to an exceptions remediation system and method, and more particularly to an exceptions remediation system and method for asset transfer.

### BACKGROUND OF THE INVENTION

Some industries, such as industries involving the sale of assets connecting buyers and sellers, manufacture assets that potentially include one or more predefined features. Each individual asset may contain a different subset of those predefined features and each feature may be of a different attribute. Human error may occur at some or all stages of the asset lifecycle, including for example during manufacture, transcription, pricing, committing, and transfer. When a transaction such as a transaction involving loans or sale of assets is finalized, the seller typically stipulates that the assets being sold have a certain set of features with specific attributes. When delivering the assets, documents and data files are typically transferred from seller to buyer to maintain the record of the data underlying the assets and to prove that the asset is identical to the features and attributes stipulated to at the time of transaction. In conventional systems, this is a labor-intensive scope of work often partially deferred by doing due diligence on a small percentage of the overall transaction and allowing for some inaccuracies to transfer based on the transaction. Typically, though, the relatively small percentage that is processed for due diligence is fraught with human error and communication challenges.

Communicating asset transfer exception details between buyer representatives and sellers is time consuming and prone to human error. Significant time is typically involved for exceptions to be identified by buyer representatives and to form and transmit a communication for the identified exceptions. Timely receipt of the communication is typically subject to seller access to the communication channel that is used. Remediation of the data associated with the exceptions usually involves forming a response with corrected details. Receipt of the response, verifying that the data successfully remediates the exception, and communicating the status back to the seller are also time-consuming.

Asset manufacture processes may also include undiagnosed issues. These undiagnosed issues can lead to persistence of bad data resulting in time consuming resolution and possibly costly transaction amendments.

Using conventional methods, sellers attempt to understand each buyer's exception report and respond by providing data updates in the buyer's specification, which is time-consuming. Further, sellers attempt to conform responses to file specifications, which is time-consuming. For example, conventional systems involve communicating exceptions to sellers, including emailing sellers a report for exceptions identified. Sellers using conventional techniques typically update data to remediate changes and email the information back to the buyer. Buyers then typically update data and run exceptions rules again, often identifying new exceptions based on new data. These conventional steps are time-consuming.

Based on conventional systems currently in use, users accept inefficiency in generating reports from databases and sharing the reports with sellers, including the significant cost of labor and time expended to manage exceptions in the conventional manual manner. Despite the cognitive demands on a seller to ingest an exceptions report and perform a remediation to a buyer specification, buyers do not provide sellers with a user-friendly alternative under conventional methods. Using conventional techniques, sellers are not asked to apply exceptions rules themselves prior to a buyer running exceptions checks, so therefore the seller does not endeavor to build a more efficient method for checking their own data without access to the buyer set of rules.

The exemplary disclosed system and method are directed to overcoming one or more of the shortcomings set forth above and/or other deficiencies in existing technology.

### SUMMARY OF THE INVENTION

In one exemplary aspect, the present disclosure is directed to a system. The system includes a remediation module, comprising computer-executable code stored in non-volatile memory, a processor, a buyer device of a buyer, and a seller device of a seller. The remediation module, the processor, the buyer device, and the seller device are configured to receive asset data of the seller, receive exception rules of the buyer, determine exceptions of the asset data based on the exception rules, display the exceptions via at least one of the buyer device or the seller device, and update the asset data based on the displayed exceptions.

In another aspect, the present disclosure is directed to a method. The method includes receiving asset data of a seller via a seller device, receiving exception rules of a buyer via a buyer device, determining exceptions of the asset data based on the exception rules, displaying the exceptions via at least one of the buyer device or the seller device, updating the asset data based on the displayed exceptions, and determining updated exceptions of the updated asset data based on the exception rules.

### BRIEF DESCRIPTION OF THE DRAWINGS

FIG. 1 is a schematic illustration of an exemplary system of the present invention;

FIG. 2 is a flowchart showing an exemplary process of the present invention;

FIG. 3 is a flowchart showing an exemplary process of the present invention;

FIG. 4 is a flowchart showing an exemplary process of the present invention;

FIG. 5 is a flowchart showing an exemplary process of the present invention;

FIG. 6 is a schematic illustration of an exemplary computing device, in accordance with at least some exemplary embodiments of the present disclosure; and

FIG. 7 is a schematic illustration of an exemplary network, in accordance with at least some exemplary embodiments of the present disclosure.

### DETAILED DESCRIPTION AND INDUSTRIAL APPLICABILITY

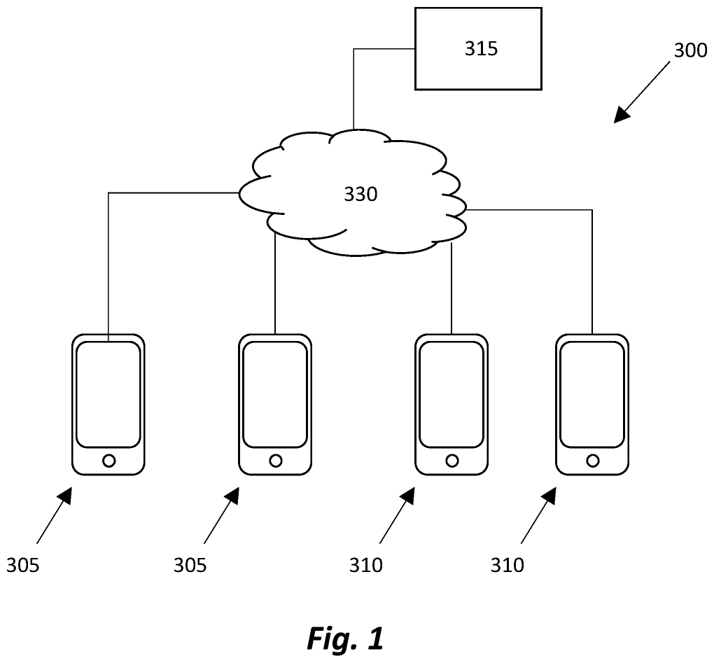

FIG. 1 illustrates an exemplary system 300 that may be used in asset transfer. For example, system 300 may be an exceptions remediation system for asset transfer. In at least some exemplary embodiments, system 300 may include an asset transfer data validation and self-serve exceptions remediation platform for example as described herein.

As illustrated in FIG. 1, system 300 may include one or more buyer devices 305, one or more seller devices 310, and one or more modules 315. For example, system 300 may include a plurality of buyer devices 305 and a plurality of seller devices 310. Any suitable type of data such as document data including text and images, audio data, image data, video data, and/or any suitable data for use in an asset transfer may be transferred between one or more buyer devices 305, one or more seller devices 310, and/or one or more modules 315 via a network 330. Data may be transferred in real-time, near real-time, and/or with any desired time intervals between the exemplary disclosed data processing and data transfer. Any suitable asset may be transferred. The assets may include numerous, conditionally-present, underlying data points. The assets may be subject to review (e.g., thorough review) at a time of transferring the assets from seller to buyer (e.g., after an economic transaction has been finalized) for example as described herein. The asset may include (e.g., or may be associated with) a loan, property (e.g., real, tangible, and/or intangible property), stock, a commodity, and/or any other suitable asset that may be transferred (e.g., bought or sold).

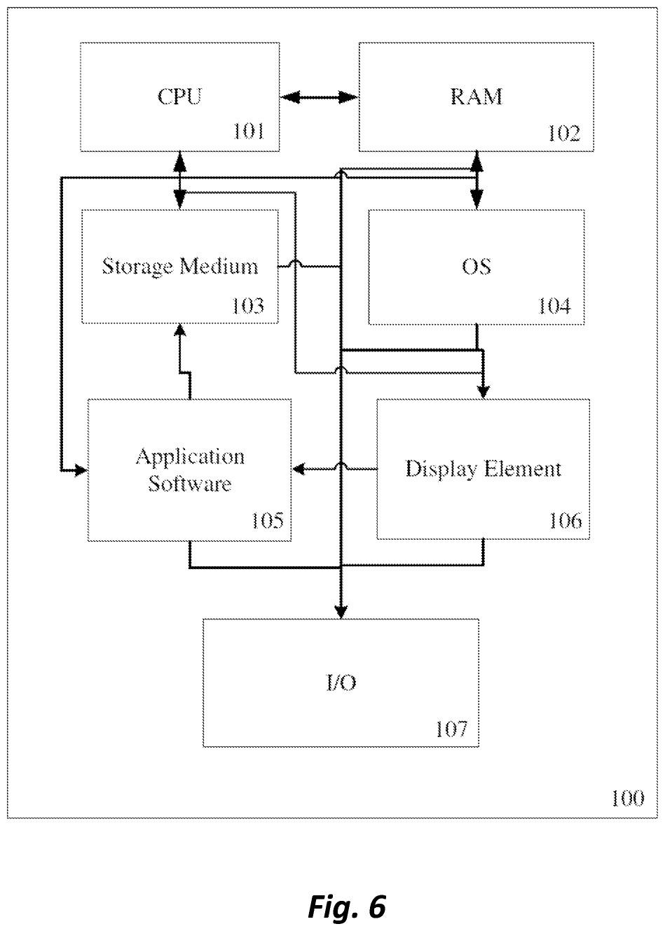

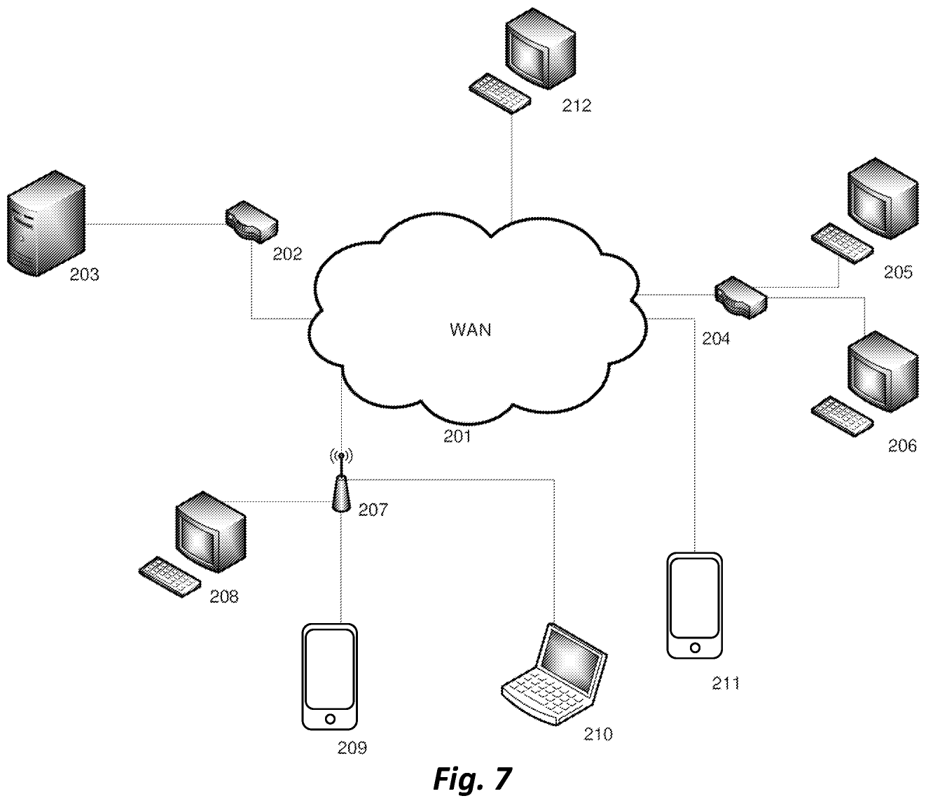

As illustrated in FIG. 1, system 300 may include any desired number of buyer devices 305. Buyer device 305 may be any suitable user device for interfacing with other components of system 300 such as a computing device (e.g., user interface). For example, buyer device 305 may be a computing device such as a desktop computer, laptop, or workstation. Also for example, buyer device 305 may be a mobile device such as a smartphone or tablet. Buyer device 305 may display a graphical user interface (GUI) for receiving and displaying input to users associated with the exemplary disclosed processes. For example, buyer device 305 may be any suitable user interface for receiving input and/or providing output (e.g., image data) to a user such as an asset buyer. Buyer device 305 may include a camera and a microphone. Buyer device 305 may be, for example, a touchscreen device (e.g., of a smartphone, a tablet, a smartboard, and/or any suitable computer device), a wearable device, a computer keyboard and monitor (e.g., desktop or laptop), an audio-based device for entering input and/or receiving output via sound, a tactile-based device for entering input and receiving output based on touch or feel, a dedicated user interface designed to work specifically with other components of system 300, and/or any other suitable user interface (e.g., including components and/or configured to work with components described below regarding FIGS. 6 and 7). For example, buyer device 305 may include a touchscreen device of a smartphone or handheld tablet. For example, buyer device 305 may include a display (e.g., a computing device display, a touchscreen display, and/or any other suitable type of display) that may provide output, image data, and/or any other desired output or input prompt to a user. For example, the exemplary display may include a graphical user interface to facilitate entry of input by a user and/or receiving output such as image data. An application (e.g., a software application associated with the exemplary disclosed module) for example as described herein and/or a web browser may be installed on buyer device 305 and utilized by a user.

System 300 may include any desired number of seller devices 310. Seller device 310 may be similar to buyer device 305. For example, seller device 310 may be any suitable user interface for receiving input and/or providing output data to a user such as an asset seller. One or more users such as asset sellers may operate seller devices 310 to exchange data associated with an asset transfer with one or more asset buyer operating buyer devices 305 via network 330 and module 315.

Network 330 may be any suitable communication network over which data may be transferred between one or more buyer devices 305, one or more seller devices 310, and/or one or more modules 315. Network 330 may be the internet, a LAN (e.g., via Ethernet LAN), a WAN, a WiFi network, or any other suitable network. Network 330 may be similar to WAN 201 described below. The components of system 300 may also be directly connected (e.g., by wire, cable, USB connection, and/or any other suitable electro-mechanical connection) to each other and/or connected via network 330. For example, components of system 300 may wirelessly transmit data by any suitable technique such as, e.g., wirelessly transmitting data via 4G LTE networks (e.g., or 5G networks) or any other suitable data transmission technique for example via network communication. Components of system 300 may transfer data via the exemplary techniques described below regarding FIG. 7. Buyer devices 305, seller devices 310, and/or modules 315 may include and/or communicate with any suitable communication components for communicating with other components of system 300 using for example the communication techniques described above. For example, buyer devices 305 and seller devices 310 may include integrally formed communication devices (e.g., smartphone components) that may communicate using any of the exemplary disclosed communication techniques. In at least some exemplary embodiments, one or more buyer devices 305, one or more seller devices 310, and/or one or more modules 315 may communicate via any suitable communication technique such as network 330, WiFi, Bluetooth, ZigBee, NFC, IrDA, and/or any other suitable communication technique.

System 300 may include one or modules 315 for performing the exemplary disclosed operations. One or more modules 315 may be stored and operated by any suitable components of system 300 (e.g., including processor components) such as, for example, network 330, one or more buyer devices 305, and/or one or more seller devices 310. For example, system 300 may include one or more modules 315 having computer-executable code stored in non-volatile memory. System 300 (e.g., module 315) may also include one or more storages (e.g., buffer storages) that may include components similar to the exemplary disclosed computing device and network components described below regarding FIGS. 6 and 7. For example, the exemplary disclosed buffer storage may include components similar to the exemplary storage medium and RAM described below regarding FIG. 6. The exemplary disclosed buffer storage may be implemented in software and/or a fixed memory location in hardware of system 300. The exemplary disclosed buffer storage (e.g., a data buffer) may store data temporarily during an operation of system 300.

The exemplary disclosed system and method may be used in any suitable application involving the sale of assets. For example, the exemplary disclosed system and method may be used in any suitable sale of assets connecting buyers and sellers. In at least some exemplary embodiments, the exemplary disclosed system and method may be used in providing sales involving loans such as mortgage loans.

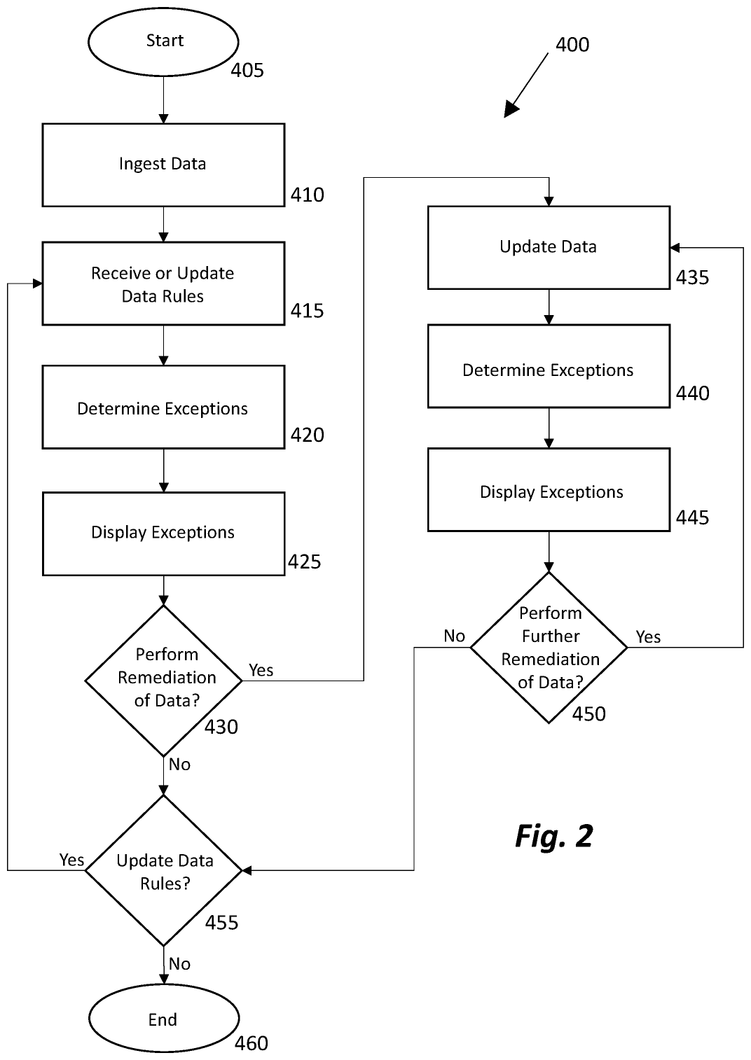

An exemplary operation of the exemplary disclosed system and method will now be described. FIG. 2 illustrates an exemplary process 400 of system 300. Process 400 begins at step 405. The exemplary disclosed module, storage (e.g., storage buffer), and hardware may include a memory having stored thereon instructions, a processor configured to execute the instructions resulting in a software application, and a software application configured to perform process 400. In at least some exemplary embodiments, users such as buyers and/or sellers may install an application of system 300 (e.g., associated with module 315) on buyer devices 305 and/or seller devices 310. Users may authorize the application to access and control functions of the exemplary disclosed user devices and/or to connect with and/or utilize any other suitable communication technique such as for example as described herein.

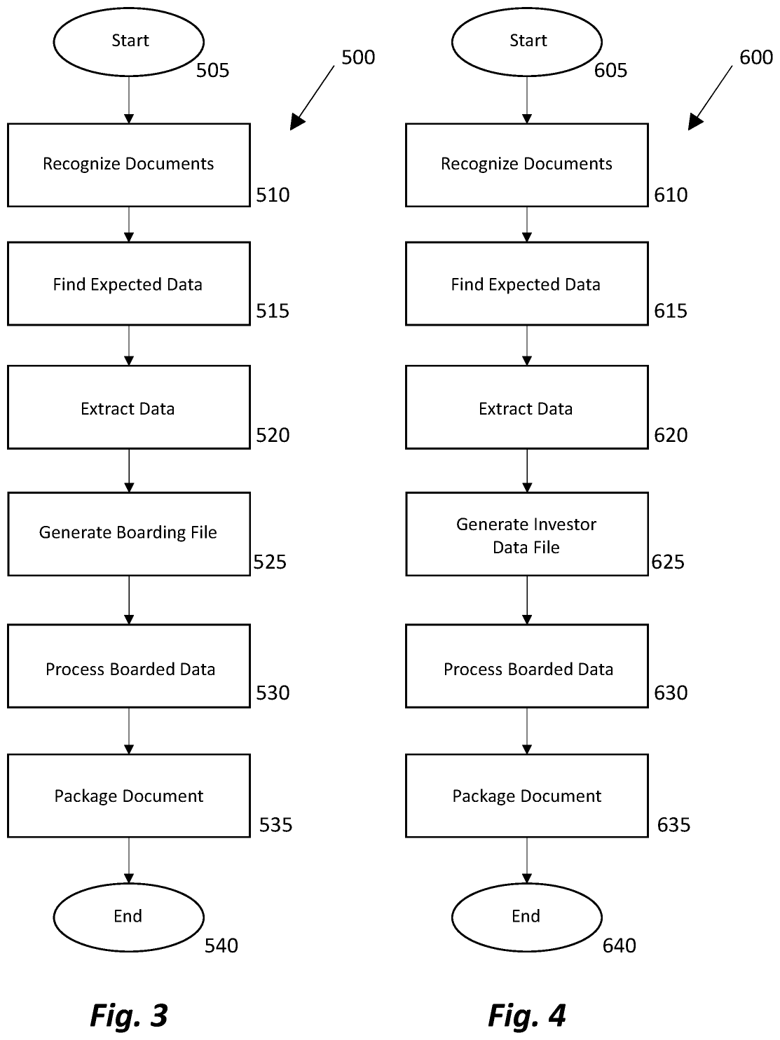

At step 410, system 300 may operate to receive (e.g., ingest) data and/or update data. System 300 may ingest and/or update data for example as described below regarding the processes of FIGS. 3-5. For example, system 300 may ingest data from sellers, buyers, third party data sources, and/or any other suitable data source for use in an asset transfer. The ingested data may include an initial data submission from one or more sellers via one or more seller devices 310. Data may be provided and/or updated via the exemplary disclosed user devices (e.g., seller devices 310 and/or buyer devices 305) based on users utilizing a GUI displayed on the devices. The ingested data may include up to thousands, tens of thousands, hundreds of thousands, or millions of data records of any desired type of data for example as described herein. For example, the ingested data may include data of hundreds of thousands or millions of mortgage loans.

At step 415, system 300 may receive, update, and/or determine data rules. System 300 may receive a population of data rules. System 300 (e.g., module 315) may receive rule specifications from one or more buyers via one or more buyer devices 305. The data rules may be exception rules. System 300 may use the exception rules provided at step 415 to provide automated analysis and identification of exceptions based on the data ingested at step 410 (e.g., and updated data as described below). The exception rules may be a predefined set of logical rules used by system 300 for determining whether the ingested data (e.g., of assets being transferred) conform to prior agreements regarding the asset transfer. The exception rules may include or be based on any suitable criteria (e.g., logical conditions) representing an existence of or a possible value (e.g., any possible value) of predetermined data points. For example, the exception rules may include logical rules for determining whether transaction terms, purchase and sale agreements, commitment details, and/or any other desired feature of the ingested data associated with the asset transfer are met. For example, the exception rules may determine whether or not ingested and/or updated data conform to a buyer's specifications (e.g., a buyer's specifications for the asset that is desired to be transferred or bought). Buyers may list explicit asset specifications that are to be met prior to accepting delivery of asset documentation and finalizing a sale (e.g., a sale that buyers and sellers of assets may enter into as part of a purchase and sale agreement). A buyer may enter the asset specifications via buyer device 305. When system 300 determines that a violation of a predefined rule of the exception rules has occurred (e.g., that ingested or updated data does not conform to a buyer's specification), system 300 may identify this violation as an “exception” for example as described below at step 420.

At step 420, system 300 may use the exception rules received, updated, and/or determined at step 415 to determine exceptions. Some or substantially all data ingested and/or updated at steps 410 (e.g., and/or step 435 described below) may be run by system 300 through the exception rules to determine whether (e.g., ensure that) ingested and/or updated data conforms to buyer specifications (e.g., for desired assets to be transferred or bought). Data updates may be run through system 300 in real-time or near real-time as they are input or received by system 300. System 300 may process and apply the exception rules to the ingested or updated data via predetermined algorithms, machine learning, and/or any other suitable technique for comparing ingested or updated data to buyer's specifications. Also for example, system 300 may operate to identify an exception type for some or substantially all exceptions (e.g., so that exceptions may be classified, categorized, grouped, and/or displayed by type at step 425 as described below). For example, system 300 may operate to group and display exceptions by exception type.

At step 425, system 300 may display exceptions determined at step 420 to users. For example, system 300 may display exceptions to buyers via buyer devices 305 and to sellers via seller devices 310. For example, buyers may view seller exceptions (e.g., exceptions associated with seller assets) via buyer devices 305. Buyer devices 305 and/or seller devices 310 may display (e.g., be used by buyers and/or sellers to view) what exceptions exist, which assets (e.g., loans or other assets) have exceptions, how many assets have exceptions, how many exceptions exist regarding seller assets, and/or any other desired exception information. Buyer devices 305 and/or seller devices 310 may display (e.g., be used by buyers and/or sellers to view) real-time or near real-time summary of assets (e.g., loans or other assets) with exceptions and/or an exception count for each asset. Buyer devices 305 and/or seller devices 310 may display (e.g., be used by buyers and/or sellers to view) a total market value of each asset (e.g., loan) having one or more exceptions. Buyer devices 305 and/or seller devices 310 may display (e.g., be used by buyers and/or sellers to view) a real-time or near real-time summary of some or substantially all exception types and/or the number of loans having that exception type and/or a total market value of loans with that exception type (e.g., and/or any other desired criteria associated with exception type).

At step 430, system 300 may determine whether or not remediation of data is to be performed. System 300 may make this determination based on user input, predetermined algorithms, machine learning (e.g., based on past user behavior), and/or any other suitable criteria. For example, a seller may provide input via seller device 310 that data is to be remediated by the seller (e.g., and/or a buyer may provide input via buyer device 305 that remediation is requested). If remediation is not to be performed, process 400 may proceed to step 455. If remediation is to be performed, process 400 may proceed to step 435.

At step 435, system 300 may operate to update (e.g., remediate) the data provided at step 410. A user such as a seller (e.g., or a buyer) may utilize seller device 310 (e.g., or buyer device 305) to remediate exceptions at a loan level by clicking an asset (e.g., a loan) via the exemplary disclosed GUI to view some or substantially all of the exceptions identified at step 420 for the asset. The user may enter data via the exemplary disclosed user device for some or substantially all exceptions. For example, the user may perform real-time or near real-time remediation of the data for some or substantially all exceptions. A user such as a seller (e.g., or a buyer) may utilize seller device 310 (e.g., or buyer device 305) to remediate exceptions at the exception level by clicking an exception type (e.g., as identified above at step 420) and viewing (e.g., seeing) some or substantially all assets (e.g., loans) having that exception type. The user may enter data via the exemplary disclosed user device for some or substantially all assets (e.g., loans of other assets) having that exception type. The user may also utilize the exemplary disclosed user device (e.g., seller device 310 or buyer device 305) to enter a batch (e.g., bulk) update for a plurality of exceptions. For example, a user may download a template (e.g., a spreadsheet or database template) that may be modified by the user via the exemplary disclosed GUI with data updates (e.g., remediating data) for a plurality of assets (e.g., multiple loans). The exemplary disclosed batch update feature may allow for batch remediation for large scale updates in a relatively quick time. The exemplary disclosed batch update may be for exceptions of a given exception type. The exemplary disclosed user device and GUI may thereby act as an interface (e.g., a self-serve interface) having features facilitating a remediation of incorrect data responsible for triggering identification of transfer exceptions at step 420. Users such as sellers may use seller device 310 (e.g., or buyer device 305) to view an exception status, correct data associated with an exception, and/or take any other suitable actions for remediating (e.g., fully remediating) some or substantially all exceptions identified at step 420 (e.g., exceptions existing in the ingested and/or updated asset data prior to delivering asset data to a buyer). Remediated data may thereby be provided (e.g., by a seller via seller device 310).

In at least some exemplary embodiments at step 435, users such as sellers (e.g., or buyers) may use the exemplary disclosed user device and GUI to view one type of exception occurring on many assets (e.g., clustering visualization). This visualization via the exemplary disclosed GUI (e.g., of seller device 310 and/or buyer device 305) may display and identify potential issues with asset origination. For example, system 300 may provide clustering by showing how many assets (e.g., loans or any other suitable asset that may be transferred for example as described herein) may have the same exception, which may allow identification of possible issues with manufacture in addition to asset data.

At step 440, system 300 may operate to determine exceptions to the data updated at step 435 that may be similar to determining exceptions at step 420 based on the data provided at step 410. System 300 may display exceptions at step 445 similarly to the display of exceptions described above at step 425. For example, data updated by the seller via seller device 310 may be rechecked by system 300 for compliance with buyer specifications using the exception rules.

At step 450, system 300 may determine whether or not further remediation of data is to be performed. The determination at step 450 may be similar to the determination described above at step 430. If further remediation is to be performed, process 400 may return to step 435. If further remediation is not to be performed, process 400 may proceed to step 455 (e.g., similarly to the determination at step 430).

If remediation of data is not to be performed at either step 430 or step 450, process 400 may proceed to step 455. At step 455, system 300 may operate to determine whether or not data rules (e.g., exception rules) are to be updated. System 300 may make this determination based on user input, predetermined algorithms, machine learning (e.g., based on past user behavior), and/or any other suitable criteria. For example, a buyer may provide input via buyer device 305 that exception rules are to be updated by the buyer (e.g., and/or a seller may provide input via seller device 310 that update of exception rules is proposed). Users such as buyers may define updated remediation criteria for the exception rules and/or may provide comments associated with remediated data of step 435. For example, users such as buyers may input data that exception rules are to be updated. If system 300 determines that exception rules are to be updated, process 400 may return to step 415, and exception rules may be updated at step 415. If system 300 determines that exception rules are not to be updated, system 300 may proceed to step 460, at which process 400 ends.

FIG. 3 illustrates an exemplary process 500 for ingesting data similar to for example step 410 of process 400. Process 500 may be a “super transfer” process. Process 500 may be an automated process for ingesting seller documents through integration with a seller-managed platform (e.g., an sftp site) or providing a user interface (e.g., GUI displayed via seller device 310) for the seller to upload data (e.g., documents) to system 300. Process 500 may be an automated process for processing documents that may be powered by machine learning. Process 500 may eliminate a burden for a seller to build a data file, and seller documents and data may be processed and delivered to a buyer in a standard desired by (e.g., specific to) a buyer. Process 500 may utilize whatever data format may be found in documents and generate a boarding file in a structure (e.g., an exact structure) and format desired by a buyer. Process 500 may run exceptions rules simultaneously (e.g., at a same time) automatically instead of utilizing two or more user-initiated processes. Process 500 begins at step 505.

At step 510, system 300 may recognize documents provided by the seller. For example, system 300 may recognize document type and document purpose using any suitable techniques such as, for example, predetermined algorithms, optical character recognition, machine learning, and/or any other suitable techniques. For example, any suitable machine learning frameworks and/or automated pipeline services may be used by system 300 for document recognition for any suitable document types and/or purposes.

At step 515, system 300 may find expected data. For example, system 300 may identify expected data on documents using any suitable techniques such as, for example, predetermined algorithms, machine learning, and/or any other suitable techniques.

At step 520, system 300 may extract data using any suitable data extraction techniques (e.g., for text data, image data, and/or any other suitable technique). For example, any suitable machine learning frameworks and/or automated pipeline services may be used by system 300 for data identification and extraction for any suitable document versions for each document type and/or purpose identified at steps 510 and 515.

At step 525, system 300 may generate a boarding file. For example, system 300 may generate a boarding file including some or substantially all data specified by a buyer for each asset (e.g., based on the buyer's specifications, which may be provided by buyers to system 300 via buyer devices 305).

At step 530, system 300 may process boarded data. For example, system 300 may process boarded data against predetermined data validation rules to identify an existence of exceptions for example as described above regarding step 420. For example, any suitable machine learning frameworks and/or automated pipeline services may be used by system 300 for scalable cloud-based processing that may implement suitable compute resources based on a size of the processing job.

At step 535, system 300 may package documents. For example, system 300 may package documents in a stacking order and/or format specified by buyers (e.g., based on the buyer's specifications, which may be provided by buyers to system 300 via buyer devices 305). Process 500 may end at step 540.

In at least some exemplary embodiments of process 500, real-time or near real-time seller feedback may be provided via seller device 310. For example, input regarding issues with system 300 being able to process documents at time of ingestion (e.g., successful upload of documents) may be provided via seller device 310.

FIG. 4 illustrates another exemplary process for ingesting data similar to for example step 410 of process 400. Process 600 may be a due diligence process. Process 600 may be an automated process for ingesting client documents through integration with a client-managed platform (e.g., an sftp site) or providing a user interface (e.g., similar to the exemplary disclosed GUI) for a client to upload documents to system 300 for due diligence. Steps 605, 610, 615, and 620 may be similar, respectively, to steps 505, 510, 515, and 520.

At step 625, which may be generally similar to step 525, system 300 may generate an investor data file. For example, system 300 may generate a data file including some or substantially all data specified by investors for a comprehensive due diligence of an asset.

At step 630, which may be generally similar to step 530, system 300 may process boarded data. For example, system 300 may process boarded data against industry regulations and/or investor rules to identify substandard documentation and/or data.

At step 635, which may be generally similar to step 535, system 300 may package a document. For example, system 300 may package documents in a stacking order and/or format specified for due diligence (e.g., additional agency due diligence). Process 600 may end at step 640.

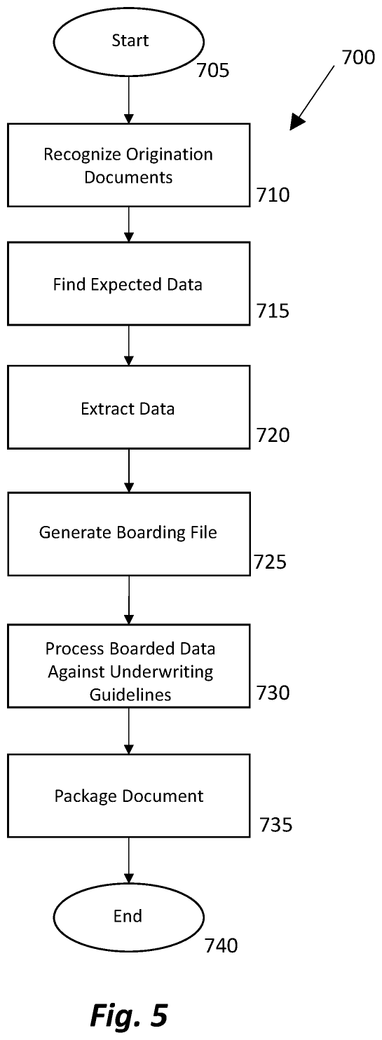

FIG. 5 illustrates another exemplary process for ingesting data similar to for example step 410 of process 400. Process 700 may be a loan origination system (LOS) process. Process 700 may be an automated process for ingesting origination documents through integration with an originator-managed platform (e.g., an sftp site) or providing a user interface (e.g., similar to the exemplary disclosed GUI) for a client to upload documents to system 300 for due diligence. Process 700 may allow upload of documents used for underwriting a loan or other asset. Steps 705, 710 (e.g., recognize origination documents), 715, 720, and 725 may be similar, respectively, to steps 605, 610, 615, 620, and 625.

At step 730, which may be generally similar to step 630, system 300 may process boarded data. For example, system 300 may process boarded data against underwriting guidelines and/or investor rules to identify substandard documentation and/or data.

At step 735, which may be generally similar to step 635, system 300 may package a document. For example, system 300 may package documents in a stacking order and/or format specified for loan delivery. Process 700 may end at step 740.

In at least some exemplary embodiments, system 300 may automate a process of identifying assets that do not conform to allowable features and attributes set specified (e.g., stipulated) in prior agreements. System 300 may provide sellers with visibility (e.g., immediate visibility) regarding assets that do not conform. System 300 may provide an efficient user interface for sellers to research and remediate assets and for buyers to monitor a progress of an entire transaction.

In at least some exemplary embodiments, the exemplary disclosed system and method may provide sellers with an intuitive user interface allowing efficient editing of data that may be causing an exception (e.g., provided directly in the exemplary disclosed application). System 300 may provide an automated process for evaluating the data of one or more assets against a population of data rules (e.g., exception rules) to identify, display, and track violations of the rules. System 300 may provide for defining one or more criteria that asset data is to satisfy before assets may be considered delivered by the seller to the buyer.

In at least some exemplary embodiments, the exemplary disclosed system and method may utilize any programming language or languages suitable for browser-based applications or native desktop applications. The exemplary disclosed system and method may provide a secure method for hosting the application such as https protocol. The exemplary disclosed system and method may provide a secure method for hosting backend and frontend servers such as proprietary encrypted hardware hosted on-site or secure cloud-based vendor-provided servers. The exemplary disclosed system and method may provide a software application to facilitate boarding loans for which mortgage servicing rights have been purchased. The exemplary disclosed system and method may provide facilitation of boarding for whole loans, HELOCs, Non-QM loans, and/or scratch and dent loans. The exemplary disclosed system and method may provide data files with populations having records that have passed the quality control specifications of the buyer and that are produced in a buyer's native format. The exemplary disclosed system and method may provide an audit log detailing which exceptions were triggered and which data points and/or when data points (e.g., some or any corresponding data points) were updated by users.

In at least some exemplary embodiments, the exemplary disclosed system and method may reduce time and effort expended to communicate exceptions by running exceptions rules (e.g., instantly) in real-time or near real-time, such that each time a seller updates data, exception rules (e.g., all exceptions rules) are run again and identify (e.g., instantly identify) any new exceptions, which may provide sellers real-time or near real-time feedback (e.g., so that exceptions may be remediated instantly rather than taking significant time to communicate for example via email). The exemplary disclosed process may eliminate data processing burdens and/or customer support burdens for buyers.

In at least some exemplary embodiments, the exemplary disclosed system and method may normalize reporting across buyers, and may be optimized to provide the seller with transparency and intuitive reporting on features such as: the market value at risk (e.g., will not be paid to seller) if seller fails to remediate exceptions; number of loans or other assets that have exceptions and how many total exceptions total in real-time or near real-time; self-serve real-time or near real-time exceptions report download; rapid (e.g., instant) feedback on new exceptions after updates (e.g., every data update); and/or secure self-serve seller access to online portal for exceptions remediation and reporting.

In at least some exemplary embodiments, the exemplary disclosed system and method may provide suitable data and documents to buyers in a desired structure and format without involving training for new sellers (e.g., during onboarding of a new seller relationship). The exemplary disclosed system and method may reduce or eliminate an onboarding burden and post-transfer work related to remediating exceptions. The exemplary disclosed system and method may also provide sellers with a user interface that may facilitate efficient review and remediation of exceptions and transparency of remediation issues in real-time or near real-time.

In at least some exemplary embodiments, the exemplary disclosed system and method may provide an intuitive buyer user interface for: specifying exceptions rules that should be run and a class of exception that may result from each exception rule, requesting new exception rules to be created, and/or tracking seller exceptions over cycles and providing remediation performance. The exemplary disclosed system and method may also provide a real-time or near real-time chat feature at a loan level, exception level, and/or specific loan exception level for buyer-seller communication and/or history of remediation discussion.

In at least some exemplary embodiments, the exemplary disclosed system may include a remediation module, comprising computer-executable code stored in non-volatile memory, a processor, a buyer device (e.g., buyer device 305) of a buyer, and a seller device (e.g., seller device 310) of a seller. The remediation module, the processor, the buyer device, and the seller device may be configured to receive asset data of the seller, receive exception rules of the buyer, determine exceptions of the asset data based on the exception rules, display the exceptions via at least one of the buyer device or the seller device, and update the asset data based on the displayed exceptions. The remediation module, the processor, the buyer device, and the seller device may be configured to determine updated exceptions of the updated asset data based on the exception rules. The remediation module, the processor, the buyer device, and the seller device may be configured to determine one or more exception types of the exceptions. The remediation module, the processor, the buyer device, and the seller device may be configured to group and display the exceptions by the one or more exception types. Updating the asset data may include performing a batch update for the exceptions having a same exception type of the one or more exception types. The remediation module, the processor, the buyer device, and the seller device may be configured to group and display all of the exceptions by the one or more exception types to the seller via the seller device. The remediation module, the processor, the buyer device, and the seller device may be configured to update the exception rules based on the displayed exceptions. The remediation module, the processor, the buyer device, and the seller device may be configured to determine additional exceptions of at least one of the asset data or the updated asset data based on the updated exception rules. Updating the asset data may include remediating the exceptions of the asset data that are mortgage loan exceptions. Receiving the asset data may include generating a boarding file of the asset data that includes data of a plurality of mortgage loans.

In at least some exemplary embodiments, the exemplary disclosed method may include receiving asset data of a seller via a seller device (e.g., seller device 310), receiving exception rules of a buyer via a buyer device (e.g., buyer device 305), determining exceptions of the asset data based on the exception rules, displaying the exceptions via at least one of the buyer device or the seller device, updating the asset data based on the displayed exceptions, and determining updated exceptions of the updated asset data based on the exception rules. The exemplary disclosed method may also include updating the exception rules based on at least one of the exceptions or the updated exceptions. The exemplary disclosed method may further include determining additional exceptions of at least one of the asset data or the updated asset data based on the updated exception rules. The exemplary disclosed method may also include determining one or more exception types of at least one of the exceptions or the updated exceptions. The exemplary disclosed method may further include grouping and displaying at least one of the exceptions or the updated exceptions by the one or more exception types. Updating the asset data may include performing a batch update for at least one of the exceptions or the updated exceptions having a same exception type of the one or more exception types.

In at least some exemplary embodiments, the exemplary disclosed system may include a remediation module, comprising computer-executable code stored in non-volatile memory, a processor, a buyer device (e.g., buyer device 305) of a buyer, and a seller device (e.g., seller device 310) of a seller. The remediation module, the processor, the buyer device, and the seller device may be configured to receive a first asset data of the seller, receive a first set of exception rules of the buyer, determine a first set of exceptions of the first asset data based on the first set of exception rules, display the first set of exceptions via at least one of the buyer device or the seller device, update the first asset data to a second asset data based on the first set of exceptions, and evaluate the second asset data using the first set of exception rules to identify violations of the first set of exception rules by the second asset data. The remediation module, the processor, the buyer device, and the seller device may be configured to determine and display a second set of exceptions of the second asset data based on evaluating the second asset data. The remediation module, the processor, the buyer device, and the seller device may be configured to update the second asset data to a third asset data based on the second set of exceptions. The remediation module, the processor, the buyer device, and the seller device may be configured to update the first set of exception rules based on the second set of exceptions.

The exemplary disclosed system and method may provide an efficient and effective technique for addressing exceptions in a transaction for a sale of an asset. For example, the exemplary disclosed system and method may provide a technique for remediating data associated with exceptions in a transaction for a sale of an asset. The exemplary disclosed system and method may reduce a time and labor burden associated with addressing exceptions in a transaction for a sale of an asset.

In at least some exemplary embodiments, the exemplary disclosed system and method may utilize sophisticated machine learning and/or artificial intelligence techniques to prepare and submit datasets and variables to cloud computing clusters and/or other analytical tools (e.g., predictive analytical tools) which may analyze such data using artificial intelligence neural networks. The exemplary disclosed system may for example include cloud computing clusters performing predictive analysis. For example, the exemplary neural network may include a plurality of input nodes that may be interconnected and/or networked with a plurality of additional and/or other processing nodes to determine a predicted result. Exemplary artificial intelligence processes may include filtering and processing datasets, processing to simplify datasets by statistically eliminating irrelevant, invariant or superfluous variables or creating new variables which are an amalgamation of a set of underlying variables, and/or processing for splitting datasets into train, test and validate datasets using at least a stratified sampling technique. The exemplary disclosed system may utilize prediction algorithms and approach that may include regression models, tree-based approaches, logistic regression, Bayesian methods, deep-learning and neural networks both as a stand-alone and on an ensemble basis, and final prediction may be based on the model/structure which delivers the highest degree of accuracy and stability as judged by implementation against the test and validate datasets.

An illustrative representation of a computing device appropriate for use with embodiments of the system of the present disclosure is shown in FIG. 6. The computing device 100 can generally be comprised of a Central Processing Unit (CPU, 101), optional further processing units including a graphics processing unit (GPU), a Random Access Memory (RAM, 102), a mother board 103, or alternatively/additionally a storage medium (e.g., hard disk drive, solid state drive, flash memory, cloud storage), an operating system (OS, 104), one or more application software 105, a display element 106, and one or more input/output devices/means 107, including one or more communication interfaces (e.g., RS232, Ethernet, Wifi, Bluetooth, USB). Useful examples include, but are not limited to, personal computers, smart phones, laptops, mobile computing devices, tablet PCs, touch boards, and servers. Multiple computing devices can be operably linked to form a computer network in a manner as to distribute and share one or more resources, such as clustered computing devices and server banks/farms.

Various examples of such general-purpose multi-unit computer networks suitable for embodiments of the disclosure, their typical configuration and many standardized communication links are well known to one skilled in the art, as explained in more detail and illustrated by FIG. 7, which is discussed herein-below.

According to an exemplary embodiment of the present disclosure, data may be transferred to the system, stored by the system and/or transferred by the system to users of the system across local area networks (LANs) (e.g., office networks, home networks) or wide area networks (WANs) (e.g., the Internet). In accordance with the previous embodiment, the system may be comprised of numerous servers communicatively connected across one or more LANs and/or WANs. One of ordinary skill in the art would appreciate that there are numerous manners in which the system could be configured and embodiments of the present disclosure are contemplated for use with any configuration.

In general, the system and methods provided herein may be employed by a user of a computing device whether connected to a network or not. Similarly, some steps of the methods provided herein may be performed by components and modules of the system whether connected or not. While such components/modules are offline, and the data they generated will then be transmitted to the relevant other parts of the system once the offline component/module comes again online with the rest of the network (or a relevant part thereof). According to an embodiment of the present disclosure, some of the applications of the present disclosure may not be accessible when not connected to a network, however a user or a module/component of the system itself may be able to compose data offline from the remainder of the system that will be consumed by the system or its other components when the user/offline system component or module is later connected to the system network.

Referring to FIG. 7, a schematic overview of a system in accordance with an embodiment of the present disclosure is shown. The system is comprised of one or more application servers 203 for electronically storing information used by the system. Applications in the server 203 may retrieve and manipulate information in storage devices and exchange information through a WAN 201 (e.g., the Internet). Applications in server 203 may also be used to manipulate information stored remotely and process and analyze data stored remotely across a WAN 201 (e.g., the Internet).

According to an exemplary embodiment, as shown in FIG. 7, exchange of information through the WAN 201 or other network may occur through one or more high speed connections. In some cases, high speed connections may be over-the-air (OTA), passed through networked systems, directly connected to one or more WANs 201 or directed through one or more routers 202. Router(s) 202 are completely optional and other embodiments in accordance with the present disclosure may or may not utilize one or more routers 202. One of ordinary skill in the art would appreciate that there are numerous ways server 203 may connect to WAN 201 for the exchange of information, and embodiments of the present disclosure are contemplated for use with any method for connecting to networks for the purpose of exchanging information. Further, while this application refers to high speed connections, embodiments of the present disclosure may be utilized with connections of any speed.

Components or modules of the system may connect to server 203 via WAN 201 or other network in numerous ways. For instance, a component or module may connect to the system i) through a computing device 212 directly connected to the WAN 201, ii) through a computing device 205, 206 connected to the WAN 201 through a routing device 204, iii) through a computing device 208, 209, 210 connected to a wireless access point 207 or iv) through a computing device 211 via a wireless connection (e.g., CDMA, GMS, 3G, 4G) to the WAN 201. One of ordinary skill in the art will appreciate that there are numerous ways that a component or module may connect to server 203 via WAN 201 or other network, and embodiments of the present disclosure are contemplated for use with any method for connecting to server 203 via WAN 201 or other network. Furthermore, server 203 could be comprised of a personal computing device, such as a smartphone, acting as a host for other computing devices to connect to.

The communications means of the system may be any means for communicating data, including image and video, over one or more networks or to one or more peripheral devices attached to the system, or to a system module or component. Appropriate communications means may include, but are not limited to, wireless connections, wired connections, cellular connections, data port connections, Bluetooth® connections, near field communications (NFC) connections, or any combination thereof. One of ordinary skill in the art will appreciate that there are numerous communications means that may be utilized with embodiments of the present disclosure, and embodiments of the present disclosure are contemplated for use with any communications means.

Traditionally, a computer program includes a finite sequence of computational instructions or program instructions. It will be appreciated that a programmable apparatus or computing device can receive such a computer program and, by processing the computational instructions thereof, produce a technical effect.

A programmable apparatus or computing device includes one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computing device can include any and all suitable combinations of at least one general purpose computer, special-purpose computer, programmable data processing apparatus, processor, processor architecture, and so on. It will be understood that a computing device can include a computer-readable storage medium and that this medium may be internal or external, removable and replaceable, or fixed. It will also be understood that a computing device can include a Basic Input/Output System (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the disclosure as claimed herein could include an optical computer, quantum computer, analog computer, or the like.

Regardless of the type of computer program or computing device involved, a computer program can be loaded onto a computing device to produce a particular machine that can perform any and all of the depicted functions. This particular machine (or networked configuration thereof) provides a technique for carrying out any and all of the depicted functions.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. Illustrative examples of the computer readable storage medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A data store may be comprised of one or more of a database, file storage system, relational data storage system or any other data system or structure configured to store data. The data store may be a relational database, working in conjunction with a relational database management system (RDBMS) for receiving, processing and storing data. A data store may comprise one or more databases for storing information related to the processing of moving information and estimate information as well one or more databases configured for storage and retrieval of moving information and estimate information.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software components or modules, or as components or modules that employ external routines, code, services, and so forth, or any combination of these. All such implementations are within the scope of the present disclosure. In view of the foregoing, it will be appreciated that elements of the block diagrams and flowchart illustrations support combinations of means for performing the specified functions, combinations of steps for performing the specified functions, program instruction technique for performing the specified functions, and so on.

It will be appreciated that computer program instructions may include computer executable code. A variety of languages for expressing computer program instructions are possible, including without limitation C, C++, Java, JavaScript, assembly language, Lisp, HTML, Perl, and so on. Such languages may include assembly languages, hardware description languages, database programming languages, functional programming languages, imperative programming languages, and so on. In some embodiments, computer program instructions can be stored, compiled, or interpreted to run on a computing device, a programmable data processing apparatus, a heterogeneous combination of processors or processor architectures, and so on. Without limitation, embodiments of the system as described herein can take the form of web-based computer software, which includes client/server software, software-as-a-service, peer-to-peer software, or the like.

In some embodiments, a computing device enables execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. The thread can spawn other threads, which can themselves have assigned priorities associated with them. In some embodiments, a computing device can process these threads based on priority or any other order based on instructions provided in the program code.

Unless explicitly stated or otherwise clear from the context, the verbs “process” and “execute” are used interchangeably to indicate execute, process, interpret, compile, assemble, link, load, any and all combinations of the foregoing, or the like. Therefore, embodiments that process computer program instructions, computer-executable code, or the like can suitably act upon the instructions or code in any and all of the ways just described.

The functions and operations presented herein are not inherently related to any particular computing device or other apparatus. Various general-purpose systems may also be used with programs in accordance with the teachings herein, or it may prove convenient to construct more specialized apparatus to perform the required method steps. The required structure for a variety of these systems will be apparent to those of ordinary skill in the art, along with equivalent variations. In addition, embodiments of the disclosure are not described with reference to any particular programming language. It is appreciated that a variety of programming languages may be used to implement the present teachings as described herein, and any references to specific languages are provided for disclosure of enablement and best mode of embodiments of the disclosure. Embodiments of the disclosure are well suited to a wide variety of computer network systems over numerous topologies. Within this field, the configuration and management of large networks include storage devices and computing devices that are communicatively coupled to dissimilar computing and storage devices over a network, such as the Internet, also referred to as “web” or “world wide web”.

Throughout this disclosure and elsewhere, block diagrams and flowchart illustrations depict methods, apparatuses (e.g., systems), and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) can be implemented by computer program instructions; by special-purpose, hardware-based computer systems; by combinations of special purpose hardware and computer instructions; by combinations of general purpose hardware and computer instructions; and so on—any and all of which may be generally referred to herein as a “component”, “module,” or “system.”

While the foregoing drawings and description set forth functional aspects of the disclosed systems, no particular arrangement of software for implementing these functional aspects should be inferred from these descriptions unless explicitly stated or otherwise clear from the context.

Each element in flowchart illustrations may depict a step, or group of steps, of a computer-implemented method. Further, each step may contain one or more sub-steps. For the purpose of illustration, these steps (as well as any and all other steps identified and described above) are presented in order. It will be understood that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

The functions, systems and methods herein described could be utilized and presented in a multitude of languages. Individual systems may be presented in one or more languages and the language may be changed with ease at any point in the process or methods described above. One of ordinary skill in the art would appreciate that there are numerous languages the system could be provided in, and embodiments of the present disclosure are contemplated for use with any language.

It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments.

It will be apparent to those skilled in the art that various modifications and variations can be made to the disclosed system and method. Other embodiments will be apparent to those skilled in the art from consideration of the specification and practice of the disclosed method and apparatus. It is intended that the specification and examples be considered as exemplary only, with a true scope being indicated by the following claims.

What is claimed is:

1. A system, comprising:
a remediation module, comprising computer-executable code stored in non-volatile memory;
a processor;
a buyer device of a buyer; and
a seller device of a seller;
wherein the remediation module, the processor, the buyer device, and the seller device are configured to:
receive asset data of the seller;
receive exception rules of the buyer;
determine exceptions of the asset data based on the exception rules;
display the exceptions via at least one of the buyer device or the seller device; and
update the asset data based on the displayed exceptions.

2. The system of claim 1, wherein the remediation module, the processor, the buyer device, and the seller device are configured to determine updated exceptions of the updated asset data based on the exception rules.

3. The system of claim 1, wherein the remediation module, the processor, the buyer device, and the seller device are configured to determine one or more exception types of the exceptions.

4. The system of claim 3, wherein the remediation module, the processor, the buyer device, and the seller device are configured to group and display the exceptions by the one or more exception types.

5. The system of claim 3, wherein updating the asset data includes performing a batch update for the exceptions having a same exception type of the one or more exception types.

6. The system of claim 3, wherein the remediation module, the processor, the buyer device, and the seller device are configured to group and display all of the exceptions by the one or more exception types to the seller via the seller device.

7. The system of claim 1, wherein the remediation module, the processor, the buyer device, and the seller device are configured to update the exception rules based on the displayed exceptions.

8. The system of claim 7, wherein the remediation module, the processor, the buyer device, and the seller device are configured to determine additional exceptions of at least one of the asset data or the updated asset data based on the updated exception rules.

9. The system of claim 1, wherein updating the asset data includes remediating the exceptions of the asset data that are mortgage loan exceptions.

10. The system of claim 1, wherein receiving the asset data includes generating a boarding file of the asset data that includes data of a plurality of mortgage loans.

11. A method, comprising:
receiving asset data of a seller via a seller device;
receiving exception rules of a buyer via a buyer device;
determining exceptions of the asset data based on the exception rules;
displaying the exceptions via at least one of the buyer device or the seller device;
updating the asset data based on the displayed exceptions; and
determining updated exceptions of the updated asset data based on the exception rules.

12. The method of claim 11, further comprising updating the exception rules based on at least one of the exceptions or the updated exceptions.

13. The method of claim 12, further comprising determining additional exceptions of at least one of the asset data or the updated asset data based on the updated exception rules.

14. The method of claim 11, further comprising determining one or more exception types of at least one of the exceptions or the updated exceptions.

15. The method of claim 14, further comprising grouping and displaying at least one of the exceptions or the updated exceptions by the one or more exception types.

16. The method of claim 14, wherein updating the asset data includes performing a batch update for at least one of the exceptions or the updated exceptions having a same exception type of the one or more exception types.

17. A system, comprising:
a remediation module, comprising computer-executable code stored in non-volatile memory;
a processor;
a buyer device of a buyer; and
a seller device of a seller;
wherein the remediation module, the processor, the buyer device, and the seller device are configured to:
receive a first asset data of the seller;
receive a first set of exception rules of the buyer;
determine a first set of exceptions of the first asset data based on the first set of exception rules;
display the first set of exceptions via at least one of the buyer device or the seller device;
update the first asset data to a second asset data based on the first set of exceptions; and
evaluate the second asset data using the first set of exception rules to identify violations of the first set of exception rules by the second asset data.

18. The system of claim 17, wherein the remediation module, the processor, the buyer device, and the seller device are configured to determine and display a second set of exceptions of the second asset data based on evaluating the second asset data.

19. The system of claim 18, wherein the remediation module, the processor, the buyer device, and the seller device are configured to update the second asset data to a third asset data based on the second set of exceptions.

20. The system of claim 18, wherein the remediation module, the processor, the buyer device, and the seller device are configured to update the first set of exception rules based on the second set of exceptions.
